(19) United States
(12) Patent Application Publication
(10) Pub. No.: US 2024/0217843 A1
(43) Pub. Date: Jul. 4, 2024

(54) POOL CHEMICAL DISPENSING SYSTEM

(71) Applicant: Pentair Water Pool and Spa, Inc., Cary, NC (US)

(72) Inventors: Rodney Byron McCall, Piedmont, SC (US); Umesh Pai, Apex, NC (US); Charles Bulger, Falcon Heights, MN (US)

(21) Appl. No.: 18/544,141

(22) Filed: Dec. 18, 2023

Related U.S. Application Data
(60) Provisional application No. 63/477,536, filed on Dec. 28, 2022.

(51) Int. Cl. C02F 1/00; C02F 1/68

(52) U.S. Cl. CPC C02F 1/008; C02F 1/685; C02F 2103/42; C02F 2209/003; C02F 2209/008

(57) ABSTRACT

An apparatus for delivering a plurality of pool chemicals is provided. The apparatus comprises a housing including at least one dispensing area. The apparatus also includes a measurement device in communication with the housing that is designed to detect a concentration of a substance in a water sample. A controller is adapted to provide a signal to the housing to dispense a pool chemical from the plurality of pool chemicals if the controller determines that the concentration of the substance is outside of a predefined range.

### CROSS-REFERENCE TO RELATED APPLICATIONS

This application claims priority under 35 U.S.C. § 119 to U.S. Provisional Patent Application No. 63/477,536, entitled “POOL CHEMICAL DISPENSING SYSTEM,” filed Dec. 28, 2022, the entire contents of which is incorporated herein by reference.

### FIELD OF INVENTION

The present disclosure is directed to a vending system for products, and more particularly, to a vending system for pool chemicals that dispenses one or more pool chemicals to a consumer, pool servicer, or other individual based on input related to physical and/or chemical parameters of the pool water.

### BACKGROUND OF INVENTION

In our increasingly complex and busy world, consumers have many needs regarding the upkeep of their homes and businesses, including pool water chemistry balancing. It is common for consumers to use products (e.g., pool chemicals) to assist them balancing their pool water chemistry. However, today's consumers are often overwhelmed by the number of products available to them and are unsure about how to find the appropriate product based on their preference for a specific brand, specific needs, or unknown needs.

Often, when searching for a specific product at a store, a consumer must analyze multiple products and read the labels located thereon to determine whether one of the products meets her needs. However, this approach is time-consuming and does not guarantee that the products the consumer selects are the best products for her needs. In fact, the consumer may not even know which products to select for the desired pool water chemistry balancing. Further, the consumer is even less likely to find or select the appropriate product when the consumer is unaware of exactly how to balance her pool's water chemistry and/or which products are available that have synergistic and beneficial chemistry-balancing implications to satisfy these unknown needs.

In some instances, stores may attempt to group like products in an in-store display. However, such displays are typically small and can only accommodate a small number of products. Further, the same types of products are typically grouped together on the display so a consumer would be unable to locate the appropriate product without picking up individual consumer products to check the labels.

Another method of balancing pool chemistry is to have a pool servicing or maintenance company visit the pool location, take a water sample, measure the water sample, and add chemicals based on the measurement. This method does not require the pool owner to understand the underlying water chemistry but is expensive and inconvenient as the pool owner must pay the company for the service, as well as schedule the maintenance calls.

Thus, there is a need in the art to facilitate consumer selection of products to meet the consumer's needs related to the maintenance of her pool.

### SUMMARY OF INVENTION

In some aspects, a vending system is provided that includes a housing and at least one product. The at least one product can adjust at least one physical parameter and/or at least one chemical parameter of pool water when at least one of the aforementioned parameters are outside of a predefined or preferred range. A controller associated with the vending system receives an input related to a value of at least one physical parameter and/or at least one chemical parameter and dispenses the appropriate at least one product to the consumer. In some instances, the controller also controls the amount of the at least one product dispensed to the consumer. The controller is in wireless or wired communication with the vending system.

In other aspects, an apparatus for delivering a plurality of pool chemicals is provided. The apparatus comprises a housing having at least one dispensing area. A measurement device is in communication with the housing and is designed to detect at least one parameter associated with a water sample, such as the concentration of a substance in the water sample. The apparatus further includes a controller that is adapted to provide a signal to the housing to dispense a pool chemical if a value of the at least one parameter (e.g., the concentration value) of the substance is detected to be outside of a predefined range.

In some instances, the apparatus further includes a wireless transmitter adapted to communicate with at least one remote device. In further instances, the measurement device is provided in the form of a colorimeter. In further instances, the measurement device is located remote from the housing. In another instance, the measurement device is positioned and located within the housing. In yet another instance, the apparatus further includes a user interface that is coupled to a wall of the housing and is in electrical communication with the controller. In other instances, the apparatus further includes a user interface in communication with the controller, and the user interface is designed to receive input information related to at least one of a pool parameter, a test parameter, user profile information, or product preferences.

In yet other aspects, an apparatus for delivering a plurality of pool chemicals is provided. The apparatus comprises a housing adapted to retain a dispensing mechanism and a controller in communication with the dispensing mechanism. The apparatus further includes a device in communication with the controller such that the device can communicate at least one input to the controller. The at least one input is used by the controller to select at least one chemical from the plurality of chemicals to dispense.

In some instances, the device may be provided in the form of a measurement device, an external device, or a user interface. In other instances, the at least one input comprises at least one value corresponding to at least one of a turbidity level, a total dissolved solids level, a pH level, an alkalinity level, a cyanuric acid concentration, an oxidation-reduction potential, a heavy metal concentration, a microbial concentration, an algae concentration, an ozone concentration, a total chlorine level, a free chlorine level, or a combined chlorine level of pool water. In other instances, information is received from a measurement device, and the information is related to at least one parameter associated with a water sample (e.g., a value of a physical property or a chemical property of the water sample). In another instance, the apparatus further includes a measurement device in communication with the housing. In further instances, the measurement device is provided in the form of a test strip, a drop test, a spectrometer, a colorimeter, or an ammeter. In yet another instance, the controller further determines a quantity of the at least one chemical to dispense from the apparatus at least partially based on a value of the at least one input.

According to yet other aspects, a method of providing a plurality of pool chemicals may include a step of providing an apparatus including a housing having a plurality of pool chemicals. The method further includes a step of obtaining a measurement of at least one parameter of pool water via a measurement device and providing the measurement of the at least one parameter to a controller. The method further includes a step of dispensing at least one pool chemical if a value of the at least one parameter is outside a predefined range.

In some instances, the at least one parameter is related to a physical property or a chemical property of the pool water. In further instances, the measurement device is provided in the form of a colorimeter. In another instance, the at least one pool chemical is dispensed in a color-coded container, and a color of the color-coded container is related to an identity of the at least one pool chemical. In yet another instance, the method further includes a step of providing instructions to a user related to administering the at least one pool chemical to the pool water. In some other instances, the method further includes a step of providing a summary of the at least one parameter to a user via at least one of a user display integral with the housing, a mobile device, or an application.

In a further aspect, a vending system for consumer products is provided. The vending system includes a controller associated with a housing. The controller is designed to execute at least one of a product recommendation module, a product selection module, a product pickup module, and a product payment module.

In some instances, the vending system could be positioned and located outside of a building, for example, a retail store or a community center. In such instances, the vending system may be designed to operate after the retail store or the community center has closed, allowing the consumer to purchase the pool chemicals after normal business hours. In other instances, the vending system is designed to provide a customized amount of a pool chemical, wherein the customized amount is an amount selected and desired by a consumer. In yet other instances, the vending system may dispense an amount of a product such that multiple doses of the product are provided to the pool or spa. In such instances, the product may include markings or indications designed to denote the amount of the pool chemical that should be dispensed to the pool or spa in a single dose. In other instances, the vending system may dispense the pool chemicals into a reusable container designed to be used by a consumer more than a single time. In some instances, the measurement device is provided remote from the housing of the vending system. In other instances, the measurement device measures the concentration of at least one substance within the pool water. In yet other instances, the controller is provided remotely from the housing of the vending system. In some instances, a water sample is delivered to the vending system by a person other than a pool owner. In yet other instances, the water sample is delivered to the vending system via a machine, such as a drone.

These and other aspects and advantages of the present invention will become apparent to those skilled in the art after considering the following detailed description in connection with the accompanying drawings.

### BRIEF DESCRIPTION OF DRAWINGS

FIG. 1 is a front schematic elevational view of a vending system constructed according to the teachings herein;

FIG. 2 is an isometric schematic view of the vending system of FIG. 1 with some portions rendered transparently for clarity;

FIG. 3 is a front schematic elevational view of various internal components of the vending system of FIG. 1;

FIG. 4 is a schematic representation of a controller for use with the vending system of FIG. 1;

FIG. 5 is a schematic isometric view of a container adapted to retain a product dispensed by the vending system of FIG. 1;

FIG. 6 is an isometric view of a dispensing system provided in the form of a pool device configured to use products dispensed by the vending system of FIG. 1;

FIG. 7 is a front elevational view of a first product, a second product, a third product, and a container dispensed from the vending system of FIG. 1, the first, second, and third products and the container each including at least one visual indicator;

FIG. 8 is a schematic representation of a controller in communication with the vending system of FIG. 1 and further in communication with a user interface;

FIG. 9 is a top plan view of an example external device adapted to communicate with the vending system of FIG. 1;

FIG. 10 is a schematic representation of a user interface that may be provided on the vending system of FIG. 1 or the external device of FIG. 9;

FIG. 11 is a schematic front elevational view of a version of the vending system of FIG. 1 further including a user interface;

FIG. 12 is a schematic representation of modules associated with a controller of the vending system of FIG. 1;

FIG. 13 is a diagram illustrating a method of using a vending system, the vending system having the properties of any of the vending systems taught herein; and

FIG. 14 is a diagram illustrating a method of using a dispensing system, the dispensing system having the properties of any of the dispensing systems taught herein.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

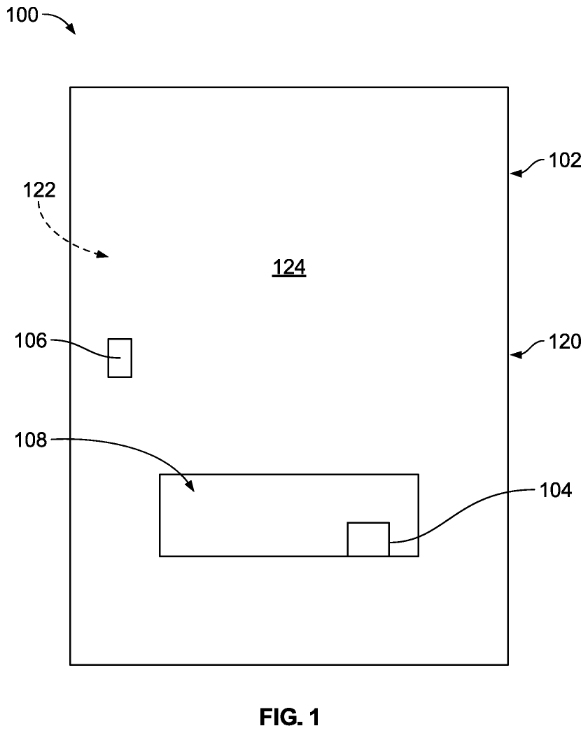

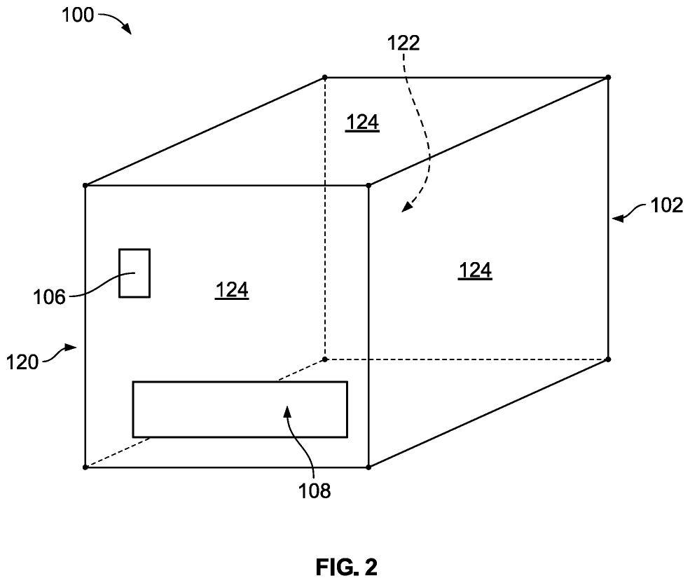

FIGS. 1 and 2 illustrate a vending system 100 generally designed to dispense one or more products to consumers. Preferably, the products are designed to assist consumers in maintaining the water quality of their pools or spas. The water quality of the pool or spa may be determined via the measurement of one or more physical parameters or chemical parameters of a sample of the pool or spa water. The physical and chemical parameters may include but are not limited to, a turbidity level, a total dissolved solids level, a pH level, an alkalinity level, a cyanuric acid concentration, an oxidation-reduction potential, a heavy metal concentration, a microbial concentration, an algae concentration, an ozone concentration, a total chlorine level, a free chlorine level, or a combined chlorine level. After determining a value of at least one physical or chemical parameter, the value of the parameter may be compared to a predefined threshold value or range. If the value of the parameter is outside of the predefined threshold range or does not equal the parameter's threshold value, the vending system 100 may provide the consumer with at least one product that will adjust a property of the water and thus, help the consumer maintain the pool or spa proper water chemistry balance.

The vending system 100 may be adapted for use by commercial servicers of pools and spas or for use by owners of commercial pool and spa systems. Furthermore, the vending system 100 may also be adapted to provide consumers with products that can maintain the quality of water delivered to their homes or businesses.

The vending system 100 may be provided in a variety of locations. For example, the vending system 100 may be provided at retail establishments, including establishments where pool chemicals and/or pool equipment are sold. As an additional example, the vending system 100 may be provided physically remote from a retail establishment. In such an instance, the vending system 100 may be provided in a location such as a community center or at a location that is not associated with a building. In each instance, the vending system 100 may operate twenty-four hours a day, or the vending system 100 may have more restricted operating hours, as determined by an operator of the vending system 100. In some instances, such as when the vending system 100 is provided outside a retail establishment, the vending system 100 may operate before or after the retail establishment's normal business hours, allowing the consumer to obtain the pool chemicals even when the retail establishment is closed.

Referring still to FIGS. 1 and 2, the vending system 100 is provided in the form of a housing 102 that is designed to dispense one or more products 104 to a consumer (not shown). The housing 102 of the vending system 100 is adapted to support and retain various components associated with the vending system 100. The vending system 100 optionally includes a sample insert site or port 106. If provided, the port 106 allows the consumer to provide a water sample to the vending system 100 for analysis. The vending system 100 may further include a product outlet or a dispensing area 108, wherein the consumer can access the products 104 dispensed by the vending system 100. The vending system 100 is configured to retain and dispense the products 104, as described in more detail below.

The housing 102 is further provided in the form of a substantially enclosed container 120 having walls defining an enclosed storage space 122 for holding the products 104. The container 120 may include a lockable door (not shown), selectively openable panel, or another mechanism that selectively allows access to the storage space 122 and other internal components of the vending system 100 by an authorized user (e.g., a repairperson, a person restocking the system, etc.). The container 120 may include one or more rigid sidewalls 124 that prevent unauthorized persons from accessing the products 104. The port 106 and the dispensing area 108 may be provided as a recess disposed in at least one sidewall 124 of the housing 102.

If the port 106 is provided, the consumer may deliver a water sample to the port 106 for testing by a measurement device. In such instances, the port 106 may be in communication with or provided as a part of the measurement device. Alternatively, the water sample may be delivered to the port 106 by other means, including by a pool serviceperson or by a drone that obtained a sample of the consumer's pool water. In some instances, such as when the port 106 is not provided as part of the vending system 100, the water sample may be delivered to a measurement device that is remote from and in communication with the vending system 100.

The dispensing area 108 is in communication with the storage space 122 and may include a mechanism (not illustrated) to prevent a consumer from reaching into the storage space 122 via the dispensing area 108. The dispensing area 108 is preferably large enough such that the product 104 can be distributed out of the storage space 122 in a manner that allows the consumer to grasp the product 104 and remove it from the vending system 100.

The storage space 122 is in communication with the dispensing area 108 that allows a consumer to access one or more products 104 that have been dispensed from the vending system 100. The storage space 122 is enclosed such that the products 104 therein are not visible. In other instances, however, one or more products 104 may be visible to the consumer through a window, through a portion of the housing 102 comprising a translucent or transparent material, via a display including a digital representation of the one or more products 104, and/or via other mechanisms.

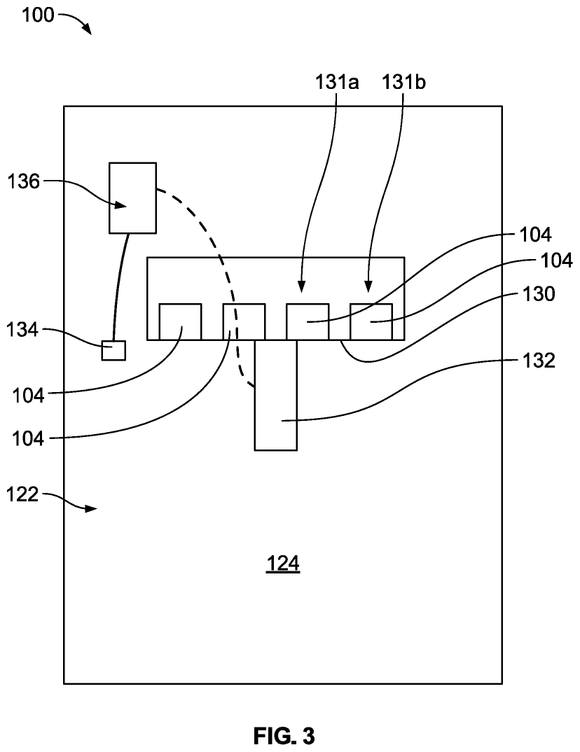

Turning to FIG. 3, the storage space 122 of the housing 102 is configured to retain the products 104 until the products 104 are dispensed from the vending system 100. The storage space 122 may be delineated within the housing 102 via one or more shelves 130, dividers, or other mechanisms, or may comprise the housing 102 itself. The storage space 122 includes products 104 that are retained within the housing 102 and/or grouped and organized by one or more characteristics including, for example, product type, pool type, chemical properties, product size, product brand, and the like. For example, the products 104 designed to adjust a pool's pH level may be grouped within a first defined area 131a within the housing 102, while products designed to adjust the chlorine levels of the pool may be provided within a second defined area 131b.

The housing 102 further includes a dispensing mechanism 132 that is designed to dispense the appropriate product 104 from the housing 102. In some instances, the dispensing mechanism 132 is provided in the form of a mechanical or robotic arm that grasps the product 104 and provides the product 104 to the dispensing area 108 (see, e.g., FIG. 2). In other instances, the housing 102 may include a series of electromechanical switches designed to open passageways and doors in the dispensing mechanism 132 to deliver the product 104 to the dispensing area 108. In a further instance, the housing 102 may include other dispensing mechanisms that provide the appropriate product 104 to the dispensing area 108, as is known in the art.

Referring again to FIG. 3, the vending system 100 may include or be in communication with a measurement device, such as a measurement device 134. Generally, if the port 106 (see, e.g., FIG. 2) is provided, the measurement device 134 may be coupled to or in fluid communication with the port 106 such that the measurement device 134 may test the water sample inserted into the vending system 100 via the port 106. The measurement device 134 may be coupled to any surface of the vending system 100 or provided within the housing 102. In some instances, the measurement device 134 may be provided remotely (e.g., physically separate) from the vending system 100. Regardless of where the measurement device 134 is provided, the measurement device 134 may communicate information about the water sample to the vending system 100 via a wired or wireless connection.

Generally, the measurement device 134 is designed to detect, directly or indirectly, at least one physical parameter and/or at least one chemical parameter of a water sample. For example, the measurement device 134 may detect a concentration of a substance within the water sample. In some instances, the measurement device 134 may detect at least one of a turbidity level, a total dissolved solids level, a pH level, an alkalinity level, a cyanuric acid concentration, an oxidation-reduction potential, a heavy metal concentration, a microbial concentration, an algae concentration, an ozone concentration, a total chlorine level, a free chlorine level, or a combined chlorine level of the water sample. To measure the at least one physical and/or chemical parameter of the water sample, the measurement device 134 may be provided in the form of a test strip, a drop test, a series of drop tests, a spectrometer, a colorimeter, an ammeter, or combinations thereof.

The at least one physical and/or chemical parameter obtained by the measurement device 134 may be provided as an input to the vending system 100. The vending system 100 may use the input to determine what product 104 or products 104 may be used to adjust the water chemistry of the consumer's pool if the at least one physical and/or chemical parameter of the water sample falls outside of a predefined range. In addition, the vending system 100 may estimate an amount of product 104 or products 104 that may re-balance the pool's water chemistry and provide an estimated amount of product 104 or products 104 to the consumer.

The vending system 100 further includes a controller 136. The controller 136 is in communication with various components of the vending system 100 (e.g., the dispensing mechanism 132 and the measurement device 134) either through a wired connection or wirelessly. The controller 136 may be adapted to control the amount and/or type of product 104 that is dispensed by the vending system 100. For example, if information is provided to the controller 136 indicating that at least one physical and/or chemical parameter of a water sample is outside of the predefined range (a “target parameter”), the controller 136 may dispense the product 104 necessary to return the target parameter to the predefined range. Additionally, if the user has provided additional information to the controller 136 regarding physical characteristics of the pool (e.g., the size of the pool), the controller 136 may dispense the amount of the product 104 necessary to bring the target parameter back into the predefined range. Furthermore, the controller 136 may cause the vending system 100 to dispense more than one product 104, including in situations where there are multiple target parameters.

The controller 136 is in communication with the measurement device 134. As discussed previously herein, the measurement device 134 may provide at least one input to the controller 136 related to at least one physical and/or chemical parameter of the water sample (e.g., a measured value related to the at least one physical and/or chemical parameter of the water sample). The at least one input may be used by the controller 136 to determine if at least one physical and/or chemical parameter is outside of a predefined range. If the controller 136 detects that one or more target parameters are outside of their respective predefined ranges, the controller 136 may cause the vending system 100 to dispense one or more products 104 that are designed to assist the consumer in returning the one or more target parameters back to their respective predefined ranges.

In some instances, the controller 136 may retain historical information related to the pool, including the pool's physical and/or chemical water properties, the size of the pool, type of pool, the products 104 provided to the consumer by the vending system 100, physical and/or chemical parameters of water provided to the pool by a water source, and the pool's usage by the consumer, and other parameters. For example, the controller 136 may retain historical information regarding the at least one physical and/or chemical parameter of water samples provided by the consumer to the vending system 100. As an additional example, the controller 136 may retain historical information related to the product 104 or products 104 dispensed to the consumer to adjust the at least one physical and/or chemical parameter of the pool. As yet another example, the controller 136 may retain historical information regarding the consumer's usage of the pool, such as the bather load of the pool. In other instances, the historical information related to the pool may be provided to a secondary controller or a server (not illustrated) wherein the information can be accessed by the controller 136.

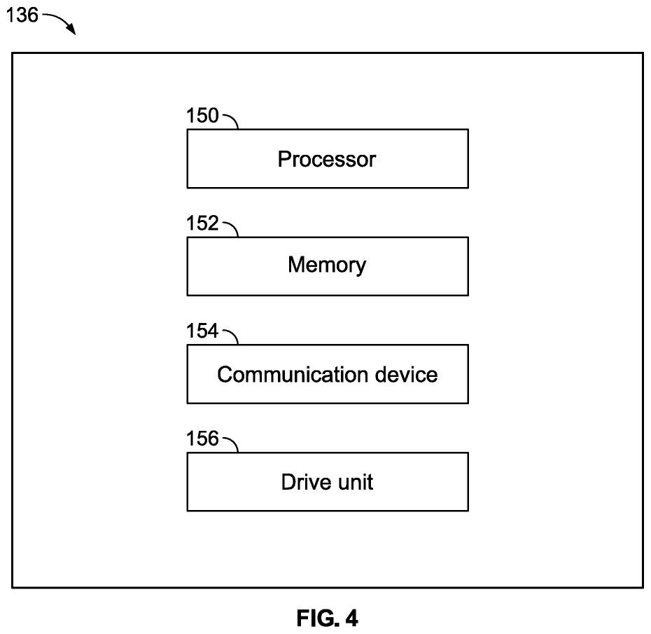

As shown in greater detail in FIG. 4, the controller 136 may be provided in the form of a computer system having one or more of a processor 150, a memory 152, a communication device 154, and a drive unit 156 with a machine-readable medium that includes software designed to store and execute modules, methodologies, and functions described herein. The software and/or data associated therewith may be transmitted and/or received over a wired and/or wireless network via the communication device 154. In some instances, the communication device 154 may be provided remotely from the controller 136. The machine-readable medium includes at least a single medium or multiple media (e.g., a centralized or distributed database, and/or associated caches and servers) that store the software and associated data. “Machine readable medium” also includes any tangible medium that is configured to store, encode, or carry executable commands (e.g., instructions) associated with the methodologies described herein. The software used by the controller 136 to determine the target parameters and the products 104 to provide to the customer may be included in the memory 152 or may be provided on a server (not illustrated) remote from the controller 136.

The controller 136 is in communication with the vending system 100. In one instance, it is contemplated that one or more components associated with the controller 136 are retained within the housing 102 of the vending system 100. In another instance, the controller 136 may be remote from the housing 102 and in communication therewith, either via a wired connection or through a wireless connection. In yet another instance, the controller 136 may be provided within a remote device including, but not limited to, a cell phone, a laptop computer, a desktop computer, a mobile device, or the like. In some instances, the controller 136 may transmit instructions to a secondary controller (not shown) disposed within the housing 102, and the secondary controller may execute instructions sent by the controller 136.

As discussed herein, the vending system 100 is designed to dispense one or more products 104. In some instances, the products 104 may be dispensed from the housing 102 in a form that is ready for use without the use of any additional components. In other instances, the vending system 100 is designed to dispense a portion of a product 104 (e.g., a refill) that is designed to be used with a dispensing aid or dispensing mechanism.

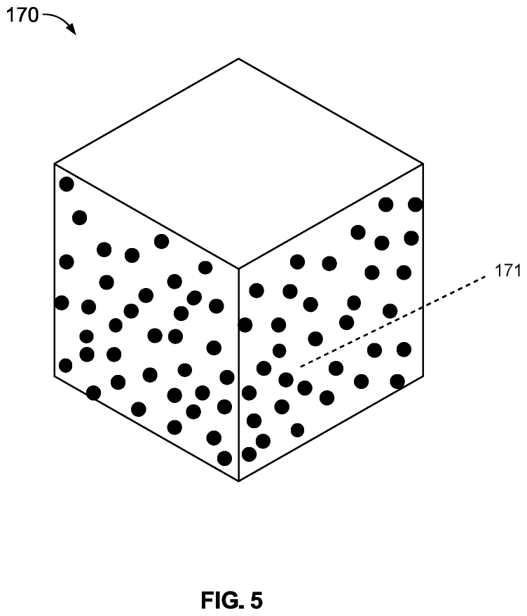

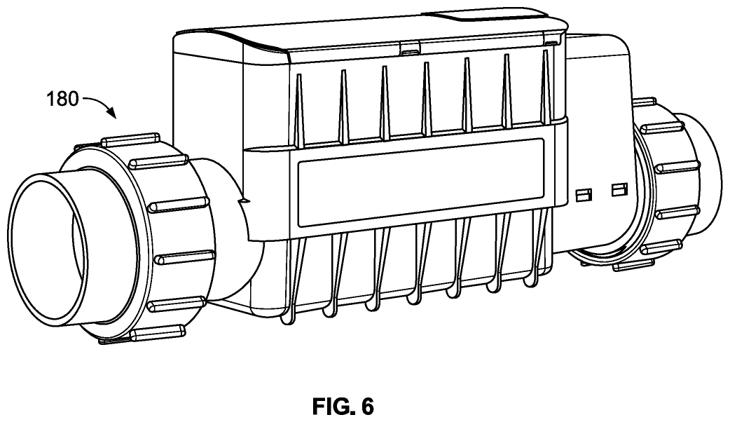

For example, as shown in FIG. 5, the product 104 may be provided in the form of a container 170 having a composition 171 retained therein. In certain instances, the container 170 may be designed to interact with a chemical dispensing mechanism 180, as illustrated in FIG. 6. Generally, the chemical dispensing mechanism 180 may help prepare and/or dispense the product 104 for use in the pool to adjust the target parameter or parameters. For example, the chemical dispensing mechanism 180 may be provided as a metering device configured to provide doses of a pool chemical over a predetermined time, or the chemical dispensing mechanism 180 may be configured to generate a target chemical (e.g., chlorine) over time when loaded with a reactant provided in the container 170. In some instances, the composition 171 may be dispensed from the container 170 and used to adjust the target parameter or parameters without the aid of a chemical dispensing mechanism 180. In other instances, the products 104 may be inserted into or used with the chemical dispensing mechanism 180 without the aid of the container 170. In yet other instances, the products 104 may be inserted or otherwise distributed into the pool directly without the aid of a container 170 and/or a chemical dispensing mechanism 180.

In some instances, the container 170 may be reusable. In such instances, the consumer may return the container 170 to the vending system 100 for reuse after the consumer has dispensed the composition 171 from the container 170. For example, the consumer may insert the container 170 into the dispensing area 108, and more of the composition 171 may be loaded or dispensed into the container 170 for the consumer. Alternatively, the consumer may return the container 170 to a designated return portion (not illustrated) of the vending system 100, and the container 170 may be loaded with additional composition 171 at a later time. As yet another alternative, the container 170 may be returned to a retail establishment, and employees of the retail establishment may return the container 170 to the vending system 100 for reuse. Advantageously, in instances wherein the container 170 is provided in the form of a reusable container, the reuse of the container 170 may reduce landfill waste generated by or associated with the operation of the vending system 100.

The composition comprising the product 104 may be any substance associated therewith. For example, the composition may be provided in any suitable form including a solid, a liquid, or a gas. In some instances, the composition may be provided in the form of a powder, a tablet, a capsule, or the like. The composition may be a chemical disposed within a carrier liquid, a chemical disposed within a carrier solid, a chemical disposed within a carrier gas, or the like, and may also comprise actives designed to adjust a particular aspect of the pool's water chemistry (e.g., turbidity, total dissolved solids, pH, alkalinity, cyanuric acid, oxidation-reduction potential, bromine, calcium, copper, other heavy metals, microbial, visible algae, ozone, total chlorine, free chlorine, and combined chlorine levels). For example, the actives may include bromine-containing compounds, chlorine-containing compounds, silver-containing compounds, copper-containing compounds, quaternary ammonia-containing compounds, monopersulfate-containing compounds, calcium hypochlorite, sodium hypochlorite, lithium hypochlorite, sodium bromide, bromamines, chloramines, oxidizers, calcium chloride, cyanuric acid, soda ash, sodium bisulfate, muriatic acid, sodium carbonate, sodium bicarbonate, polyhexamethylene biguanide or other biguanide-containing compounds, ammonium chloride salts, borates, sodium dichloro-s-triazinetrione, clarifiers, phosphate removers, algicides, bactericides, virucides, oil removal enzymes, other similar substances, and combinations of the foregoing.

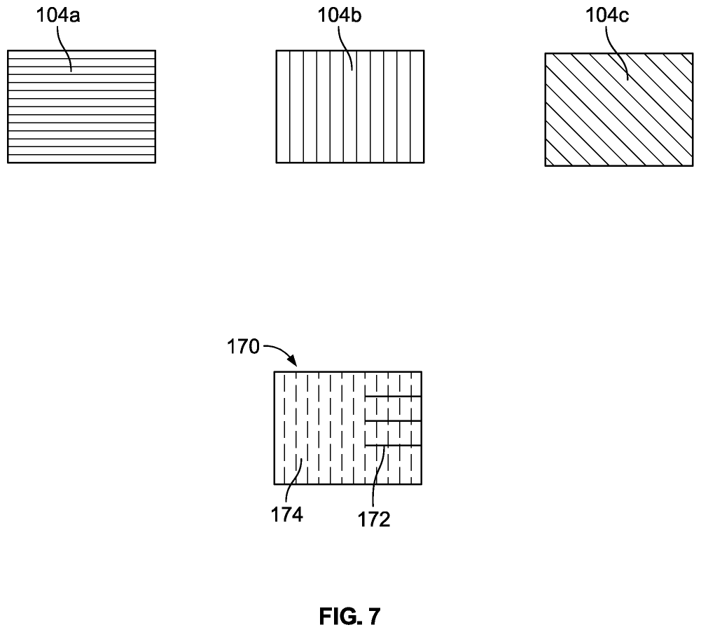

Turning now to FIG. 7, in some instances, the product 104 and/or the container 170 may be provided with a visual indicator. The visual indicator may help consumers distinguish between the types of compositions provided therein. For example, a first product 104a, a second product 104b, and a third product 104c are provided as different compositions. As such, each product 104a, 104b, and 104c is provided with the visual indicator in the form of color coding (i.e., the first product 104a is provided with a first color code, the second product 104b is provided with a second color code, and the third product 104c is provided with a third color code). By way of example, the provided color codes may be present throughout the entire composition of the product 104, may be provided on a visible surface of the product 104, and/or may be provided on a visible surface of the container 170.

Each color code may be associated with a particular type of composition as predetermined by the operator of the vending system 100 and/or a product manufacturer. For example, the first color code may indicate that the product 104a is a chlorine-containing substance, the second color code may indicate that the product 104b is an acid, and the third color code may indicate that the product 104c is an oxidizer. Alternatively, color codes may be used to indicate the presence of hazardous chemicals; in such a case, a first color code may indicate a chemical that is relatively safe to handle (e.g., sodium chloride tablets), and a second color code may indicate a relatively hazardous chemical (e.g., a concentrated acid). In some instances, the products 104 and/or the containers 170 may include multiple color codes that convey multiple types of information to the consumer. The number of color codes that may be associated with the products 104 is not particularly limited. In some instances, the product 104 may include text, QR codes, and/or other elements that may be used to convey information about the product 104.

In some instances, the controller 136 can be adapted to provide a “multi-dose” amount of pool chemical in the container 170. The multi-dose amount of pool chemical may allow the consumer to provide more than a single dose of the pool chemical to the pool or spa. Preferably, a multi-dose amount of the pool chemical is provided when the vending system 100 provides the consumer with a liquid pool chemical or when the consumer requests that the vending system 100 provide a multi-dose amount of the pool chemical.

In such an instance, the container 170 may include one or more dose markings 172 designed to visually indicate to the consumer the amount of pool chemical associated with a single dose of the pool chemical. For example, the dose markings 172 may be provided in the form of lines positioned and located on an outside surface 174 of the container 170, as illustrated in FIG. 7. As an additional example, the container 170 may include another type of graphical marking designed to inform the consumer of the amount of pool chemical to provide per dose of the chemical.

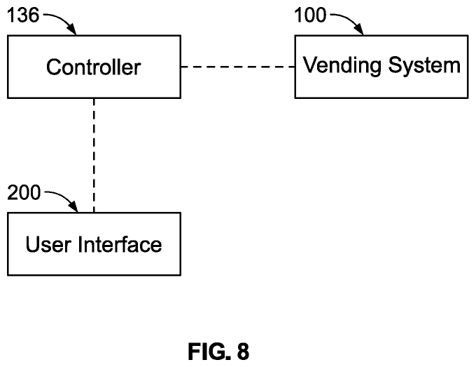

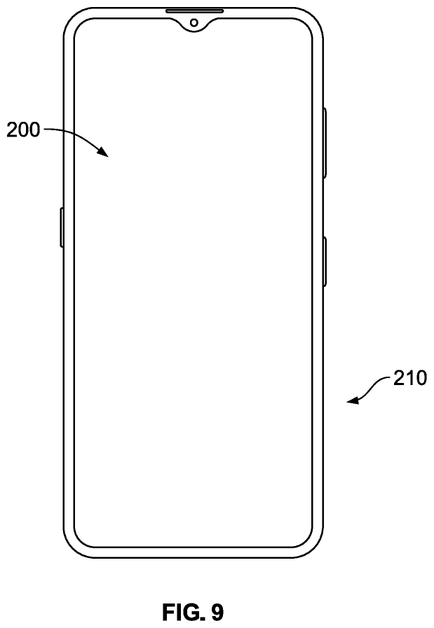

In some instances, the controller 136 may be adapted to provide the consumer with a customized amount of the pool chemical. For example, the customized amount may be an amount of a pool chemical necessary to provide a single dose of the pool chemical to the pool or spa. As an additional example, the customized amount may be an amount of a pool chemical such that a multi-dose amount of the pool chemical is provided. In such instances, the customized amount may be an amount of a pool chemical selected by the user via one or more user interfaces 200 (the one or more user interfaces 200 are discussed, e.g., with reference to FIGS. 8 and 9). Further, the customized amount of the pool chemical may be provided within the container 170 which includes the dose markings 172. Advantageously, when the customized amount is provided as a single dose of the pool chemical, the need for the consumer to store excess pool chemical at his or her home is reduced, which in turn decreases opportunities for the pool chemical to spoil, harden, or become unusable during a storage period.

As shown in FIG. 8, the controller 136 may be in communication with the one or more user interfaces 200. The user interface 200 may be provided on or coupled to the housing 102 of the vending system 100. In addition, the user interface 200 may also be provided on one or more external devices 210 (e.g., see FIG. 9) in communication with controller 136. Generally, the user interface 200 may provide information to the consumer regarding the vending system 100, the products 104 retained within the vending system 100, the price of the products 104, instructions for using the products 104, hazardous material warnings, and the like. In addition, the user interface 200 may generally be used by the consumer to input information, such as personally identifying information, payment information, information related to her pool, and the like. In some instances, the information input by the consumer may be used to construct a user profile that is unique to the consumer. Additionally, the user profile information may be coupled with information that the consumer has provided about her pool, such as the pool's size or the pool's typical bather load. Such user profile information may be stored locally in a memory of the vending system 100 (e.g., in the memory 152 associated with the controller 136), or the profile information may be stored remotely from the vending system 100.

In some instances, the user interface 200 may allow a consumer to input at least one of a pool parameter related to the physical characteristics of her pool (e.g., size of pool, type of pool water, and the like), a test parameter related to the water chemistry of the pool, user profile information, and product preferences. In some instances, the information input via the user interface 200 may be provided to the vending system 100 and may in turn be used by the controller 136 to customize the products 104 that are dispensed to the consumer. Alternatively, or in addition, the information may be provided to a remote server that processes the information and provides it to a network of vending systems 100 in communication with the remote server. In some instances, all information entered into the user interface 200 and/or obtained by the vending system 100 may be communicated to and/or stored within an app that can be activated by the external device 210.

As illustrated in FIG. 9, the user interface 200 may be provided on the external device 210. The external device 210 may be provided in the form of a desktop computer, a laptop computer, a tablet, a smart and/or cellular phone, and/or other electronic communication devices. In some instances, the measurement device 134 may be coupled to the external device 210. The controller 136 may transmit and/or receive data from the external devices 210, for example, to prepare the product 104 for pickup prior to a consumer physically interacting with the housing 102.

In some instances, the controller 136 is designed to transmit a stream of prompts or commands, as will be discussed in more detail below, to the user interface 200. Further, the user interface 200 may also provide an input to the controller 136. The user interface 200 is configured to display information and receive input from a consumer, thereby enabling a consumer to control the vending system 100 during one or more modules and/or through a series of transactions, discussed in more detail below.

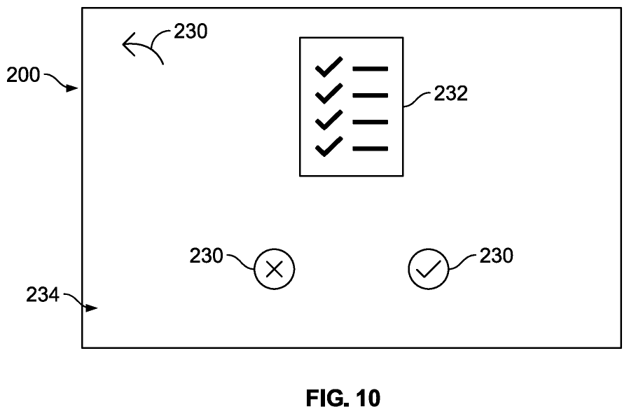

As shown in FIG. 10, the user interface 200 of the vending system 100 includes at least one input component 230 and at least one output component 232. In some instances, the input and output components 230, 232 may be combined into a single interface 234 (e.g., a touchscreen). Each of the input components 230 may include one or more of a touchscreen element, a keyboard, a keypad, a mouse, a voice recognition device, mechanical buttons, or another device suitable for enabling information to be input into the vending system 100 by a consumer. The output component 232 may be provided in the form of a display screen and/or speakers for enabling information to be output from the vending system 100 to the consumer.

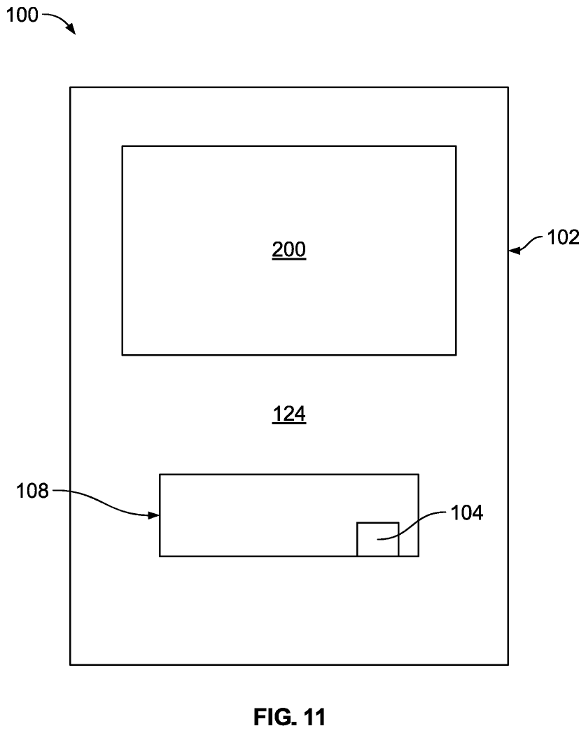

As illustrated in FIG. 11, the user interface 200 may be associated with the vending system 100. For example, the user interface 200 may be provided on or within any sidewall 124 of the housing 102 or may be provided within any sidewall 124. The user interface 200 may be provided as a screen that may display information and/or prompts to a user of the vending system 100. In response to the prompts, the user may input information into the vending system 100 that allows the vending system 100 to customize the type or types and/or the amount of products 104 to dispense from the dispensing area 108. In some instances, the user may input responses to the prompts via the external device 210 (see FIG. 9) in communication with the controller 136 (see, e.g., FIG. 8). In other instances, the user interface 200 may be provided as a touchscreen designed to allow the user to provide the vending system 100 with responses to the prompts by touching certain locations on the user interface 200.

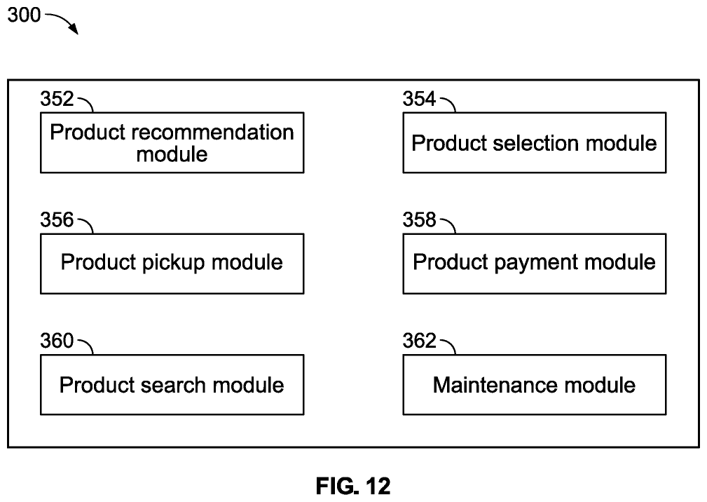

Referring to FIG. 12, the controller 136 (not illustrated) of the vending system 100 is designed to execute one or more modules 300 associated therewith. Information regarding the one or more modules 300 may be displayed or provided to the consumer via the user interface 200 (see, e.g., FIG. 11). Each module of the one or more modules 300 is designed to guide the consumer through one or more functions associated with the vending system 100. The vending system 100 may operate in one or more of a product recommendation module 352, a product selection module 354, a product pickup module 356, a product payment module 358, a product search module 360, a maintenance module 362, and any other modules consistent with the methodologies discussed herein.

The product recommendation module 352 is provided to guide the consumer through a series of prompts that result in the consumer obtaining the desired product 104. For example, the product recommendation module 352 may prompt the consumer to provide a water sample to the measurement device 134 and may ask the consumer a series of questions related to the characteristics of her pool. Then, the product recommendation module 352 may provide a product recommendation to the consumer based on the chemical and/or physical parameters of the water sample provided to the vending system 100 and/or based on the characteristics of the pool. Furthermore, if the consumer's brand preferences are known or associated with the consumer's user profile, the product recommendation module 352 may recommend certain products 104 to the consumer based on the predefined brand preferences.

The product recommendation module 352 may also include additional features that, for example, provide product 104 recommendations based on additional factors that are communicated to the controller 136. For example, the product recommendation module 352 may recommend a product 104 based on various additional factors including, the past purchase history of the consumer, demographic information of the household associated with the pool, the type of pool (e.g., fresh water or salt water), the pool's typical bather load, the amount of sunlight the pool receives in a typical day, popular products being provided by the vending system 100, promotional products, products being purchased by consumers with pools in the same neighborhood, city, or state as the user, and the like. The product recommendation module 352 may provide the product 104 based on one or more of the above factors in conjunction with the consumer's answers to any prompts and/or physical parameters and chemical parameters associated with the pool.

In some instances, the user can transmit to the vending system 100 the physical and chemical parameters and/or the additional factors by utilizing the user interface 200. In other instances, the physical and chemical parameters and/or the additional factors can be estimated via historical information provided by the consumer previously. In yet other instances, the physical and chemical parameters and/or the various additional factors can be estimated via information obtained by the vending system 100 about pools in proximity to the consumer's pool.

Within the product recommendation module 352, boost options may allow the consumer to further customize the product 104 by adding an additional component or water chemistry feature to the product 104. For example, the consumer may choose to add one or more of an antibacterial agent, an antiviral agent, an antimicrobial agent, a chlorine-containing agent, an oxidizing agent, a pH-adjusting agent, a water hardness adjustment agent, or the like, to the product 104. In some instances, the product recommendation module 352 may disallow certain boost options if a particular selection could cause a pool's water chemistry levels to be outside of the predetermined range.

After providing a water sample to the port 106 or transmitting the water sample measurements to the vending system 100, a consumer may interact with a finish button (not illustrated) provided on the user interface 200. The finish button may or may not be provided in the form of an icon. The finish button may include text, such as the words “Buy Now,” which indicates to the user that they can select the finish button to complete their transaction. A payment amount may also be displayed on the user interface 200 having the total price of the product 104, including any customization options selected by the user. In some instances, the finish button may be provided on the external device 210. In yet other instances, the user may complete the desired transaction by providing payment information to the vending system 100, or a server remote from the vending system 100, via the external device 210.

In some instances, a confirmation screen may be provided to the consumer on the user interface after the consumer interacts with the finish button. The confirmation screen may prompt the consumer to verify the choice of the product 104 and any customization options. In addition, the confirmation screen may include a payment icon or prompt that allows the consumer to pay for the product 104 using the user interface 200. When the user interacts with the payment icon or prompt, the user interface 200 may then enter the product payment module 358, described in more detail below, or the user interface 200 may allow the user to pay for the product 104 using other payment methodologies.

After payment, a product fulfillment screen may be displayed on the user interface 200 to alert the consumer that the product 104 is being prepared to be dispensed from the housing 102. Text and/or one or more graphics may appear on the user interface 200 to provide a visual representation that the product 104 is being prepared for dispensing. In other instances, an alert may be provided to the user via the user interface 200.

The product selection module 354 may allow a consumer to manually select a product retained within the vending system 100 for purchase. In other instances, the consumer may use the product selection module 354 to find a product 104 by specifying a problem she has observed with her pool. In some instances, the consumer may be unaware of the specific type of products 104 that are available to remedy the specific problem or problems that the consumer is facing. If the consumer selects the text or icon associated with a type of problem, for example, the consumer will then be presented with further options, to guide the consumer to the desired product 104.

In some instances, the user interface 200 may display various types of problems that the consumer may encounter while owning a pool when the product selection module 354 is selected. For example, the user interface 200 may display a problem type selection screen having types of problems provided in the form of, by way of example, chlorine imbalance, pH imbalance, alkalinity imbalance, high water turbidity, poor water coloring, and the like. The consumer's selection of a particular problem may prompt the vending system 100 to ask the consumer to provide an appropriate water sample, transmit information to the vending system 100 related to a water sample measurement, and/or recommend a particular product to correct an issue. If a product recommendation is provided, after the selection of the desired product 104, the consumer may customize and/or purchase the product 104.

The product pickup module 356 may be activated if the consumer has provided information to the vending system 100 before physically interacting with the vending system 100. In some instances, the product pickup module 356 may allow a consumer to obtain products 104 without using the modules 352 and/or 354. For example, if the consumer remotely transmits data from a measurement device 134 to the vending system 100, the vending system 100 may prepare one or more products 104 for future pickup by the consumer. Accordingly, the consumer may provide a water sample to a measurement device 134 in communication with the vending system 100 or the external device 210 such that the vending system 100 can recommend certain products 104 for pre-order based on the water sample measurement.

After the order has been placed, the consumer may pick up the pre-ordered products 104 at the vending system 100. One or more of the screens associated with the user interface 200 may allow a consumer to enter an order confirmation code, and/or additional identifying information that allows the consumer to easily acquire the pre-ordered product 104 without going through the various screens or modules presented herein.

The product payment module 358 is designed to allow the consumer to pay for purchases at the vending system 100. The vending system 100 may include various hardware components to facilitate payment via the product payment module 358. For example, the housing 102 may include a device for obtaining data from a credit card (e.g., a contactless credit card reader) and/or a device for receiving and/or dispensing physical currency. The controller 136 and/or the credit card device may be in communication with a payment processor to authenticate and/or confirm payment of the product 104. In addition, the product payment module 358 may store and retrieve payment information such that a consumer may pay for the products 104 without physically swiping a credit card or inputting currency into the housing 102. For example, the controller 136 may retrieve saved credit card information associated with the specific consumer purchasing the products 104. The consumer may also prepay for the product 104 using, for example, the product pickup module 356, in which the consumer may have previously input payment information into the external device 210. In some instances, the consumer may pay for the product 104 via an app or a program provided on the external device 210 such that the consumer may obtain the product 104 from the vending system 100 by entering an order confirmation code, and/or additional identifying information without requiring the consumer to go through the product payment module 358 described herein.

The product search module 360 is designed to allow the consumer to search for a specific product 104. A search box and or/alphanumeric keypad (either physical or touch screen) may be presented to allow the consumer to type in specific information about the product 104 that the consumer is looking for. Some search options may include, for example, brand, problem, pool type, recommendations by others, popular products, and the like.

The maintenance module 362 allows the vending system 100 to be configured, restocked, repaired, and reconciled at the end of a shift and/or day, and the like. In some instances, the maintenance module 362 may provide alerts when maintenance is required.

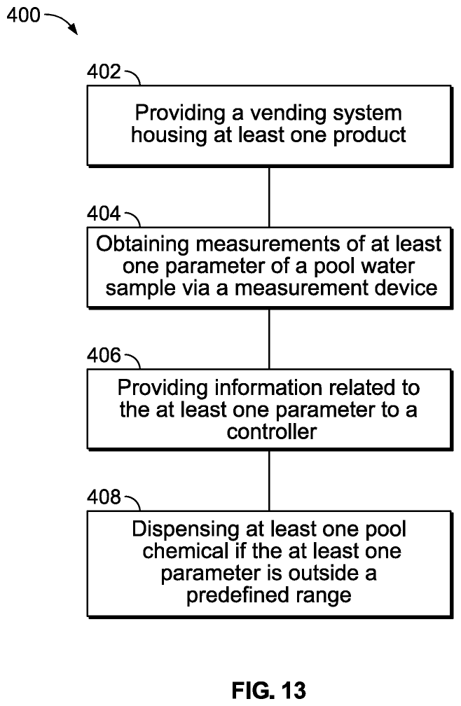

As shown in FIG. 13, a method 400 for obtaining at least one chemical from a vending system is also provided. The method 400 may include a step 402 of providing a vending system retaining at least one product. The method 400 may further include a step 404 of obtaining at least one measurement of at least one parameter of a pool water sample via a measurement device. In some instances, the measurement device may comprise a colorimeter. In other instances, the at least one parameter is related to at least one of a chemical parameter and/or a physical parameter of the water sample. The method 400 may also include a step 406 of providing information related to the at least one parameter to a controller in communication with the vending system. The method 400 may further include a step 408 which includes dispensing at least one pool chemical if the at least one parameter is outside a predefined range. In some instances, the at least one pool chemical is dispensed in a color-coded container, and a color of the color-coded container is related to an identity of the at least one pool chemical.

In some instances, the method 400 further comprises an optional step of providing instructions to a user related to administering the at least one pool chemical to the pool water. In yet other instances, the method 400 further comprises an optional step of providing a summary of the at least one parameter to a user via at least one of a user display integral with the housing, a mobile device, or an app.

In some instances, the method 400 may comprise fewer or additional steps than those described herein.

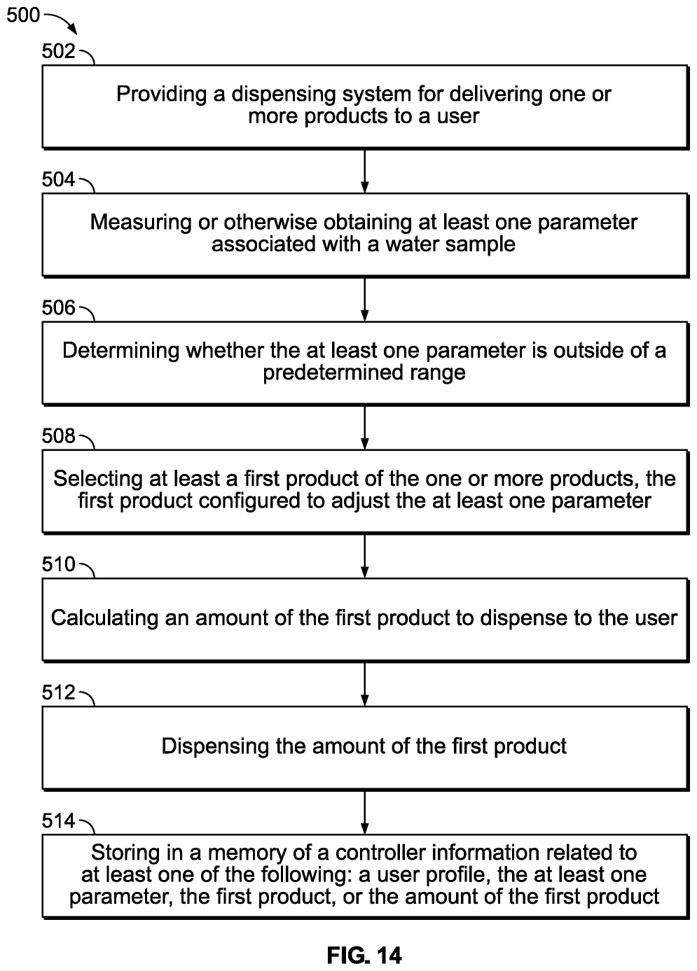

As illustrated in FIG. 14, a method 500 for dispensing at least one product configured to adjust a parameter associated with a water sample is provided. The method 500 may include a step 502 of providing a dispensing system for delivering one or more products to a user. The method 500 may also include a step 504 of measuring or otherwise obtaining at least one parameter associated with a water sample. In some instances, the at least one parameter may be measured by a measurement device in communication with the dispensing system. In other instances, the at least one parameter may be obtained via a user interface. The method 500 may further include a step 506 of determining whether the at least one parameter is above or below a predetermined range or a predetermined threshold value.

The method 500 may also include a step 508 of selecting at least a first product of the one or more products, the first product configured to adjust the at least one parameter. In some instances, one or more additional products from the one or more products may be selected, the one or more additional products each configured to adjust the at least one parameter. The method 500 may further include a step 510 of calculating an amount of the first product to dispense to the user. In some instances, the amount of the first product is configured to adjust the at least one parameter. In other instances, the amount of the first product may be configured to adjust the target parameter to a value within the predetermined range. In further instances, the amount of the first product may be a multi-dose amount of the first product. Furthermore, in instances where one or more additional products were selected, an amount for each of the one or more additional products may be calculated as well.

The method 500 may also include a step 512 of dispensing the amount of the first product. Moreover, in instances where one or more additional products were selected, the amounts of the one or more additional products may be dispensed as well. The method 500 may further include a step 514 of storing in a memory of a controller information related to at least one of the following: a user profile, the at least one parameter, the first product, or the amount of the first product. In some instances, the information related to the user profile may include information that is unique to the consumer. For example, the information related to the user profile may include the consumer's brand preferences, the consumer's past purchase history, demographic information of the household associated with the consumer, information regarding physical characteristics of the consumer's pool, and the consumer's payment information.

In some instances, the method 500 may comprise fewer or additional steps than those described herein.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses in applications that do not depart from the spirit and scope of the present inventions are deemed to be covered by the inventions which are limited only by the claims which follow.

1. An apparatus for delivering a plurality of pool chemicals, comprising:
a housing including at least one dispensing area;
a measurement device in communication with the housing, the measurement device designed to detect a concentration of a substance in a water sample; and
a controller adapted to provide a signal to the housing to dispense a pool chemical of the plurality of pool chemicals if the controller determines the concentration of the substance is outside of a predefined range.

2. The apparatus for delivering a plurality of pool chemicals of claim 1 further comprising a wireless transmitter adapted to communicate with at least one remote device.

3. The apparatus for delivering a plurality of pool chemicals of claim 1, wherein the measurement device is provided in the form of a colorimeter.

4. The apparatus for delivering a plurality of pool chemicals of claim 1, wherein the measurement device is located remote from the housing.

5. The apparatus for delivering a plurality of pool chemicals of claim 1, wherein the measurement device is positioned and located within the housing.

6. The apparatus for delivering a plurality of pool chemicals of claim 1 further comprising a user interface coupled to a wall of the housing, the user interface in communication with the controller.

7. The apparatus for delivering a plurality of pool chemicals of claim 1 further comprising a user interface in communication with the controller, wherein the user interface is designed to receive input information related to at least one of a pool parameter, a test parameter, user profile information, or product preferences.

8. An apparatus for delivering a plurality of pool chemicals, the apparatus comprising:
a housing having a pool chemical product retained therein and a dispensing mechanism designed to dispense the pool chemical product;
a controller in communication with the dispensing mechanism; and
a device in communication with the controller;
wherein the device communicates at least one input to the controller, the at least one input used by the controller to select the pool chemical product from a plurality of pool chemical products to dispense.

9. The apparatus of claim 8, wherein the device is provided in the form of at least one of a measurement device, an external device, or a user interface.

10. The apparatus of claim 8, wherein the at least one input comprises at least one value corresponding to at least one of a turbidity level, a total dissolved solids level, a pH level, an alkalinity level, a cyanuric acid concentration, an oxidation-reduction potential, a heavy metal concentration, a microbial concentration, an algae concentration, an ozone concentration, a total chlorine level, a free chlorine level, or a combined chlorine level of a pool water.

11. The apparatus of claim 8, wherein the device is designed to receive information from a measurement device, and wherein the information is related to at least one parameter associated with a water sample.

12. The apparatus of claim 8 further comprising a measurement device in communication with the controller.

13. The apparatus of claim 12, wherein the measurement device is selected from the group consisting of a test strip, a drop test, a spectrometer, a colorimeter, an ammeter, and combinations thereof.

14. The apparatus of claim 8, wherein the controller further determines a quantity of the pool chemical product to dispense from the apparatus utilizing a value of the at least one input.

15. A method of providing a plurality of pool chemicals, the method comprising:
providing an apparatus comprising a housing, the housing including the plurality of pool chemicals;
obtaining a measurement of at least one parameter of pool water via a measurement device;
providing the measurement of the at least one parameter to a controller; and
dispensing at least one pool chemical if the at least one parameter is outside a predetermined range.

16. The method of claim 15, wherein the at least one parameter is associated with a chemical property of the pool water.

17. The method of claim 15, wherein the measurement device is provided in the form of a colorimeter.

18. The method of claim 15, wherein the at least one pool chemical is dispensed in a color-coded container, and wherein a color of the color-coded container is related to an identity of the at least one pool chemical.

19. The method of claim 15 further comprising a step of providing instructions to a user related to administering the at least one pool chemical to the pool water.

20. The method of claim 15 further comprising a step of providing a summary of the at least one parameter to a user via at least one of a user display integral with the housing, a mobile device, or an application.
